(19) United States
(12) Patent Application Publication
(10) Pub. No.: US 2026/0236575 A1
(43) Pub. Date: Aug. 13, 2026

(54) APPARATUS AND METHOD FOR REAL-TIME SECURITY MONITORING OF ARM-BASED EMBEDDED SYSTEMS

(71) Applicant: ELECTRONICS AND TELECOMMUNICATIONS RESEARCH INSTITUTE, Daejeon (KR)

(72) Inventors: Seyoung BAIK, Daejeon (KR); Deokjin KIM, Daejeon (KR); Sangwook LEE, Daejeon (KR)

(21) Appl. No.: 19/085,172

(22) Filed: Mar. 20, 2025

(30) Foreign Application Priority Data
Feb. 13, 2025 (KR) 10-2025-0018814

(51) Int. Cl. G06F 21/55

(52) U.S. Cl. CPC G06F 21/554; G06F 2221/034

(57) ABSTRACT

Disclosed herein is an apparatus and method for real-time security monitoring of an embedded system. The method may include identifying one or more protection targets in the system, generating trap code for watchpoint-based monitoring for each of the identified one or more protection targets, setting a detection interval for each of the one or more protection targets, porting the generated trap code to correspond to the detection interval set for each of the protection targets, performing security monitoring for each of the one or more protection targets at the detection interval set for the protection target when the system operates, and performing exception handling by executing the ported trap code when abnormal access is detected.

### CROSS REFERENCE TO RELATED APPLICATION

This application claims the benefit of Korean Patent Application No. 10-2025-0018814, filed Feb. 13, 2025, which is hereby incorporated by reference in its entirety into this application.

### BACKGROUND OF THE INVENTION

### 1. Technical Field

The disclosed embodiment relates to technology for detecting security threats by dynamically monitoring embedded systems.

### 2. Description of Related Art

Embedded systems often interact with various external devices, such as USBs, network devices, and sensors, by operating in conjunction therewith. However, these external devices may serve as a path for malicious code to infiltrate embedded systems.

Particularly, external devices of unmanned vehicles and real-time control systems are exposed to radio frequency attacks, such as sensor jamming, and software vulnerability threats. However, technology capable of detecting and responding to such attacks and threats is currently relatively lacking.

Currently, most threat detection techniques rely on methods of analyzing stored data based on sensor logs. However, defending against various attacks executed through anomalous paths requires low-level security monitoring based on processor information.

Meanwhile, Data Watchpoint and Trace (DWT) is a hardware debugging feature provided by ARM processors, and, using DWT, read and write operations on a specific memory address or registers may be monitored in real time.

However, DWT may generally monitor only 4-byte memory regions through DWT_COMP0 to DWT_COMP3, so a detection range is limited. As a result, it is difficult to monitor various points into which attacks may flow, such as Memory-Mapped I/O (MMIO) regions and Direct Memory Access (DMA) control blocks. Although it is possible to expand the range of monitoring by changing mask values, this is a method of allocating contiguous memory addresses and is not suitable when the memory region to be monitored is not contiguous or when several specific addresses are separately tracked.

### SUMMARY OF THE INVENTION

An object of the disclosed embodiment is to monitor security at a low level based on processor information in order to defend against various attacks executed through anomalous paths in an embedded system.

Another object of the disclosed embodiment is to expand a detection range to include non-contiguous memory regions or multiple specific registers by utilizing a Data Watchpoint and Trace (DWT) debugging feature in an ARM-based embedded system.

A method for real-time security monitoring of an embedded system according to an embodiment may include identifying one or more protection targets in an embedded system, generating trap code for watchpoint-based monitoring for each of the identified one or more protection targets, setting a detection interval for each of the one or more protection targets, porting the generated trap code to correspond to the detection interval set for each of the protection targets, performing security monitoring for each of the one or more protection targets at the detection interval set for the protection target when the embedded system operates, and performing exception handling by executing the ported trap code when abnormal access is detected.

Here, the protection targets may include at least one of Static Random-Access Memory (SRAM), external RAM, a peripheral, a DMA control block, or an MMIO region, or a combination thereof.

Here, identifying the one or more protection targets may comprise determining the protection targets based on a result of analyzing an external device operating in conjunction with an embedded system, processor information, and an operation method.

Here, the detection interval may be set depending on the importance of the protection target.

Here, setting the detection interval may comprise setting a Real-Time Operating System (RTOS) timer for the detection interval of each of the one or more protection targets.

Here, performing the security monitoring may comprise dynamically resetting the one or more protection targets in a single DWT watchpoint register, thereby performing time-sharing monitoring.

Here, performing the exception handling may comprise calling, by the executed trap code, an exception handler routine defined in the embedded system and performing at least one of blocking access to the protection target, rebooting the embedded system, or switching to a defensive mode, or a combination thereof.

Here, performing the exception handling may comprise transmitting an abnormal access log to a security server or transmitting a warning message to an administrator of the embedded system.

An apparatus for real-time security monitoring of an embedded system according to an embodiment includes memory in which at least one program is recorded and a processor for executing the program, and the processor may identify one or more protection targets in an embedded system, generate trap code for watchpoint-based monitoring for each of the identified one or more protection targets, set a detection interval for each of the one or more protection targets, port the generated trap code to correspond to the detection interval set for each of the protection targets, perform security monitoring for each of the one or more protection targets at the detection interval set for the protection target when the embedded system operates, and perform exception handling by executing the ported trap code when abnormal access is detected.

Here, the protection targets may include at least one of SRAM, external RAM, a peripheral, a DMA control block, or an MMIO region, or a combination thereof.

Here, when identifying the one or more protection targets, the processor may determine the protection targets based on a result of analyzing an external device operating in conjunction with the embedded system, processor information, and an operation method.

Here, the detection interval may be set depending on the importance of the protection target.

Here, when setting the detection interval, the processor may set an RTOS timer for the detection interval of each of the one or more protection targets.

Here, when performing the security monitoring, the processor may perform time-sharing monitoring by dynamically resetting the one or more protection targets in a single DWT watchpoint register.

Here, when performing the exception handling, the processor may cause the executed trap code to call an exception handler routine defined in the embedded system and perform at least one of blocking access to the protection target, rebooting the embedded system, or switching to a defensive mode, or a combination thereof.

Here, when performing the exception handling, the processor may transmit an abnormal access log to a security server or transmit a warning message to an administrator of the embedded system.

A method for real-time security monitoring of an embedded system according to an embodiment may include performing security monitoring for each of two or more protection targets at a time-sliced detection interval preset for the protection target by utilizing a single watchpoint register when an embedded system operates; and performing exception handling in such a way that the protection target executes previously ported trap code when abnormal access is detected.

Here, the protection targets may include at least one of SRAM, external RAM, a peripheral, a DMA control block, or an MMIO region, or a combination thereof.

Here, an RTOS timer may be set for the time-sliced detection interval of each of the two or more protection targets.

Here, performing the exception handling may comprise calling, by the executed trap code, an exception handler routine defined in the embedded system and performing at least one of blocking access to the protection target, rebooting the embedded system, or switching to a defensive mode, or a combination thereof.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic configuration diagram of an embedded system to which an embodiment is applied;

FIG. 2 is a view for explaining a general DWT-based security monitoring method in an embedded system;

FIG. 3 is a view for explaining a DWT-based security monitoring method in an embedded system according to an embodiment;

FIG. 4 is a flowchart for explaining a method for real-time security monitoring of an embedded system according to an embodiment; and

FIG. 5 is a view for explaining a general unmanned vehicle control process.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

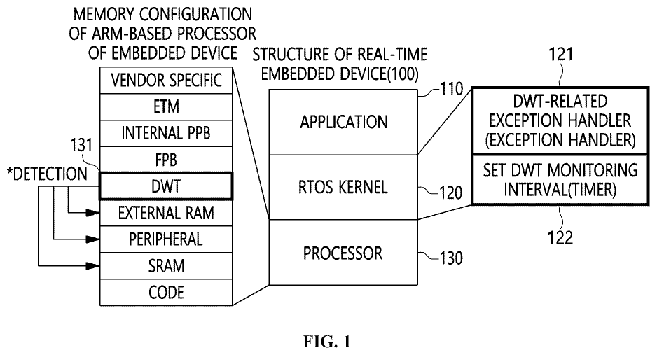

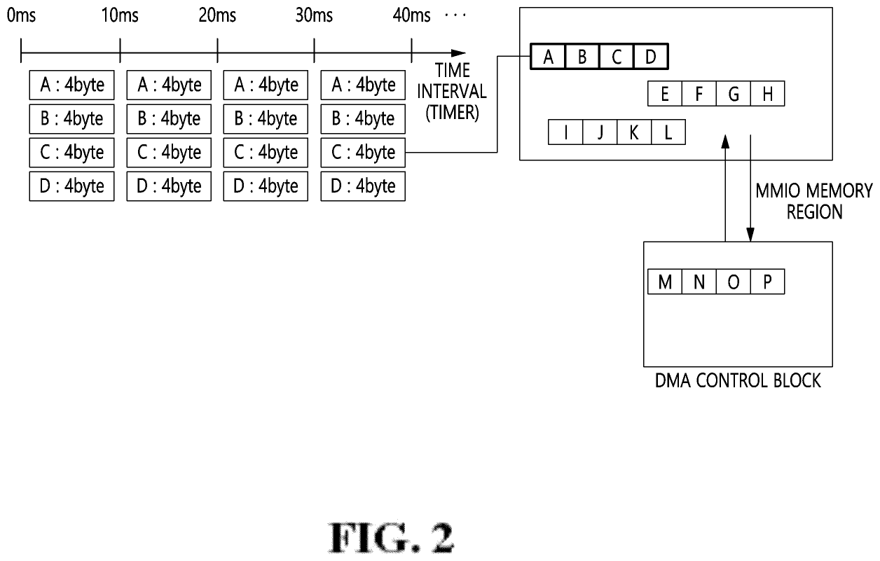

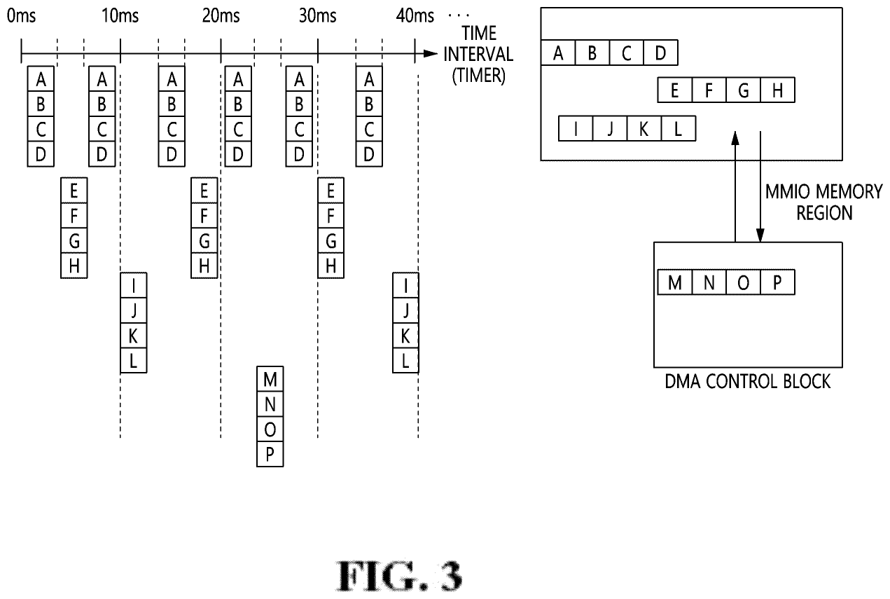

FIG. 1 is a schematic configuration diagram of an embedded system to which an embodiment is applied, FIG. 2 is a view for explaining a general DWT-based security monitoring method in an embedded system, and FIG. 3 is a view for explaining a DWT-based security monitoring method in an embedded system according to an embodiment.

Referring to FIG. 1, an embedded system to which an embodiment is applied may include an application 110, an RTOS kernel 120, and a processor 130.

The processor 130 is an ARM-based processor of the embedded device, and may include a Data Watchpoint and Trace (DWT).

Such a DWT-based monitoring system may detect threats in real time while minimizing impacts on performance, and this is an essential factor for embedded devices such as real-time critical unmanned vehicles.

Here, the DWT 131 may monitor external RAM, a peripheral, SRAM, code, and the like.

The RTOS kernel 120 may include a DWT-related exception handler 121, and a DWT monitoring interval setting unit 122.

The DWT monitoring interval setting unit 122 may set a timer for a detection interval for detecting whether an anomaly occurs based on the DWT.

The DWT-related exception handler 121 may perform exception handling when an anomaly is detected based on the DWT.

Meanwhile, Table 1 below shows an example of DWT registers related to ARMv7 processors and information about each of the registers.

TABLE 1
DWT_COMPn: 4 comparison registers for
monitoring memory addresses
DWT_MASKn: Set a monitoring range
DWT_FUNCTIONn: Set operations to be
monitored (read/write/command).
DWT_CTRL: Enable all functions of
DWT and set watchpoints
DEMCR: A register for enabling debug
functions including DWT

Referring to Table 1, there are four DWT registers, so only four protection targets may be selected and monitored based on the DWT.

For example, referring to FIG. 2, it shows that, assuming that protection targets are ABCD~MNOP, only ABCD is selected and monitored. That is, the remaining regions EFGH~MNOP may not be monitored.

In an embodiment, in order to overcome the hardware limitations of DWT (four watchpoints each having a size of four bytes), the monitoring region of DWT is expanded in a time-sharing manner using an RTOS timer, whereby specific memory regions and registers are monitored in real time.

For example, referring to FIG. 3, when protection targets are ABCD~MNOP, different monitoring intervals are set for ABCD, EFGH, IJKL, and MNOP, whereby the monitoring region of the DWT is expanded in a time-sharing manner.

That is, conventional technology allows each of the registers DWT_COMP0 to DWT_COMP3 to monitor only a memory region of four bytes, but an embodiment applies a time-sharing method based on an RTOS timer, thereby dynamically expanding the monitoring range. As a result, the monitoring range of a single watchpoint is expanded, whereby a wider memory region and registers may be efficiently monitored.

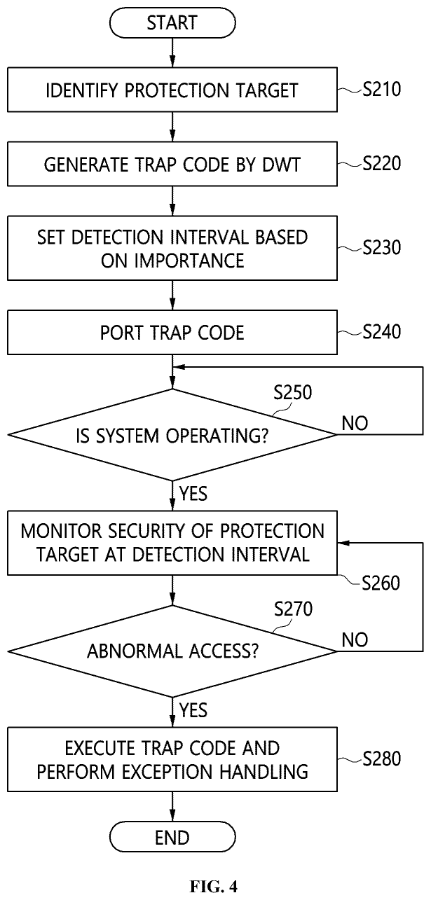

FIG. 4 is a flowchart for explaining a method for real-time security monitoring of an embedded system according to an embodiment.

Referring to FIG. 4, the method for real-time security monitoring of an embedded system according to an embodiment may include identifying one or more protection targets in an embedded system at step S210, generating trap code for watchpoint-based monitoring for each of the one or more protection targets at step S220, setting a detection interval for each of the one or more protection targets at step S230, porting the generated trap code to correspond to the detection interval set for each of the protection targets at step S240, performing security monitoring for each of the one or more protection targets at the detection interval set for the protection target at step S260 as the embedded system operates at step S250, and performing exception handling by executing the ported trap code at step S280 when abnormal access is detected at step S270.

The above-described method for real-time security monitoring of an embedded system according to an embodiment focuses on detecting security threats and expanding the detection range by dynamically monitoring specific registers, especially in unmanned vehicles and real-time control systems.

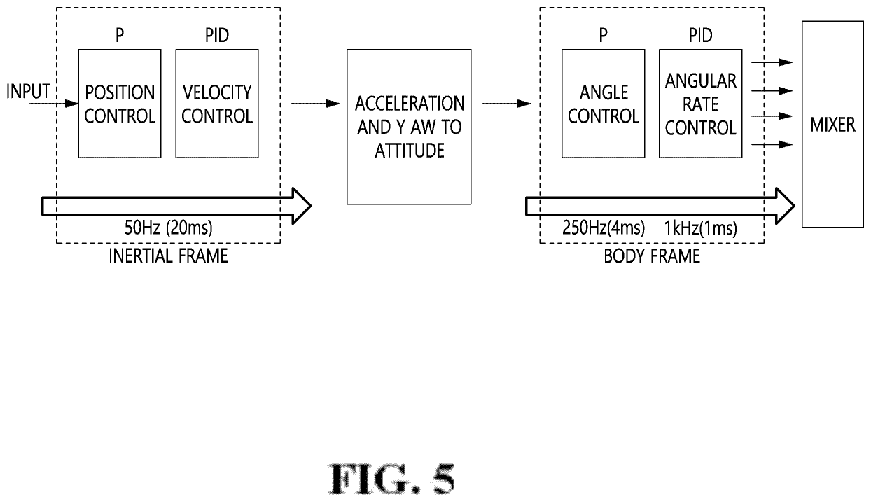

FIG. 5 is a view for explaining a general unmanned vehicle control process.

Referring to FIG. 5, a controller in which P and PID controllers are cascaded is used.

First, in an inertial frame, position, velocity, and attitude information are input from a GPS, an accelerometer, a gyroscope, and the like. The overall flight status of a drone is monitored at a 50 Hz frequency (20 ms). Then, in a body frame, immediate attitude control is performed at a frequency of 250 Hz to 1 kHz (about 1 ms).

That is, in the unmanned vehicle, control is performed by alternately repeating the inertial frame and the body frame, so detection intervals of multiple protection targets in the unmanned vehicle are adjusted by applying the method for real-time security monitoring of an embedded system according to an embodiment, whereby real-time monitoring may be performed.

Therefore, the method for real-time security monitoring of an embedded system according to an embodiment will be described in detail below by taking application of the method to an unmanned vehicle as an example. However, this is an example for helping understanding of the present disclosure, and the present disclosure is not limited thereto.

At the step (S210) of identifying one or more protection targets in an embedded system according to an embodiment, the protection targets required to be monitored using watchpoints (DWT_COMP0 to DWT_COMP3) of DWT are set.

Here, the protection targets may include at least one of SRAM, external RAM, a peripheral, a DMA control block, or an MMIO region, or a combination thereof.

For example, in the case of a Pixhawk vox unmanned vehicle control system, different protection targets may be identified in the initialization step and the operation step. That is, in the initialization step, a Universal Asynchronous Receiver-Transmitter (UART), a Serial Peripheral Interface (SPI), and internal memory registers, which are critical to flight control, may be set as protection targets.

Here, the protection targets may be set based on a result of analyzing external devices operating in conjunction with the embedded device, processor information, and the operation method.

For example, in the case of the Pixhawk vox unmanned vehicle control system, registers of Table 3 below may be identified as protection targets based on the result of analyzing the operation of external devices such as those illustrated in Table 2 below.

TABLE 2
Use of DMA: 4 DMA channels are used. (e.g.,
an IMU sensor, an altitude sensor, etc.)
UART: 3 registers are used. (e.g., a distance
sensor, radar, etc.)
SPI: 4 registers are used. (e.g., a GPS sensor, etc.)

TABLE 3
DMA registers to be protected: DMA1_Stream1_CR,
DMA1_Stream2_CR, DMA1_Stream3_NDTR
GPIO registers to be protected: GPIOE_MODER,
GPIOE_ODR, GPIOC_PUPDR
UART registers to be protected: USART1_DR,
USART2_SR, USART3_CR1
SPI registers to be protected: SPI1_CR1, SPI2_SR,
SPI1_DR

Subsequently, at the step (S220) of generating trap code according to an embodiment, trap code is generated as shown in Table 4 below in order to monitor the protection targets, which are identified as described above, using Data Watchpoint and Trace (DWT).

```
TABLE 4
// monitor UART register
DWT->COMP0 = UART1_BASE_ADDRESS; // memory address of UART1
DWT->MASK0 = 0x3; // monitor in 4-byte units
DWT->FUNCTION0 = DWT_FUNCTION_READ | DWT_FUNCTION_WRITE;
  // monitor read/write
// monitor SPI register
DWT->COMP1 = SPI2_BASE_ADDRESS; // memory address of SPI2
DWT->MASK1=0x3;  // monitor in 4-byte units
DWT->FUNCTION1 = DWT_FUNCTION_READ | DWT_FUNCTION_WRITE;
  // monitor read/write
// monitor internal memory region
DWT->COMP2 = SRAM_BASE_ADDRESS + 0x1000; // specific memory block
address
DWT->MASK2=0x3;  // monitor in 4-byte units
DWT->FUNCTION2 = DWT_FUNCTION_WRITE; // monitor write operation
```

Meanwhile, at the step (S230) of setting the detection interval, the detection interval may be determined depending on the importance of the protection target. That is, the protection target with high importance may be more frequently monitored at shorter intervals, and the protection target with low importance is monitored at relatively longer intervals, whereby degradation of the performance of the embedded system may be minimized.

Here, when setting the detection interval, an RTOS timer may be set for the detection interval of each of the one or more protection targets. Accordingly, an optimal solution for maintaining an appropriate security level while preventing performance degradation is provided.

According to the set detection interval, the state of each of the protection targets may be monitored in real time through the DWT register, and the detection interval may be dynamically adjusted according to need. The set trap code is applied to the system at a kernel level, whereby the protection target is continuously monitored at the set detection intervals.

For example, increasing the number of monitoring targets to 16 using four fixed DWT registers will be described based on the unmanned vehicle, Pixhawk v6x.

The monitoring interval is dynamically changed depending on the importance of the target to be monitored, and the 16 targets to be monitored are handled in a time-sharing manner. Accordingly, real-time security monitoring may be effectively performed while minimizing the impacts on the flight performance.

For example, when a timer expires every 10 ms, if the number of targets to be monitored is increased to 16 (a total of four external devices), the detection interval for the UART status register (UART_SR) and the DMA channel data transfer size register (DMA_CNDTR), which have relatively high importance, may be set to 10 ms, the detection interval for the GPS SPI status register (SPI_SR) and an additional memory region, which have relatively low importance, may be set to 100 ms, and the remaining 12 registers and memory regions may be divided and monitored at respective intervals.

Also, at the step (S260) of performing security monitoring according to an embodiment, the embedded system, such as an unmanned vehicle, executes a real-time security monitoring function during actual operation.

Here, the one or more protection targets may be dynamically reset in a single DWT watchpoint register for time-sharing monitoring. That is, the DWT based on time-sharing is dynamically changed according to the set detection interval, whereby real-time monitoring of a wide detection range may be performed.

Here, depending on the detection interval set at step S230, the target with high importance is repeatedly monitored every 10 ms, and the other targets are sequentially monitored.

For example, when the timer expires every 10 ms, four DWT watchpoints that are currently being monitored are sequentially swapped, whereby four targets selected from among 16 targets are monitored.

That is, UART_SR, DMA_CNDTR, additional memory, and SPI_SR may be monitored in the time period of 0 ms to 10 ms, UART_SR, DMA_CNDTR, register 1, and register 2 may be monitored in the time period of 10 ms to 20 ms, UART_SR, DMA_CNDTR, register 3, and register 4 may be monitored in the time period of 20 ms to 30 ms, and UART_SR, DMA_CNDTR, register 5, and register 6 may be monitored in the time period of 30 ms to 40 ms.

Also, when the timer expires every 100 ms, the protection targets with low importance, such as a GPS SPI and additional memory, are monitored every 100 ms, and the four watchpoints are swapped every 100 ms to handle the monitoring target with low importance.

Meanwhile, when abnormal access to the set protection target is detected through the DWT at step S270, the trap code performs exception handling at step S280.

Here, the abnormal access may occur when abnormal write, read, or access to the register or memory region where the DWT is set is attempted.

Here, at the step (S280) of performing exception handling according to an embodiment, the executed trap code may call the exception handler routine defined in the embedded system, and switching to a defense function may be performed through the associated event handler function.

Here, the defense function may include at least one of blocking access to the protection target, such as the register or the memory region, recording a system security log, rebooting the embedded system, switching to a defensive mode, transmitting an abnormal access log to a security server, or transmitting a warning message to the administrator of the embedded system, or a combination thereof. Also, according to need, a defensive process may be activated to protect the embedded system from external attacks. Accordingly, it is possible to process threats in real-time and maintain stable operation.

According to the disclosed embodiment, a method for monitoring the states of memory and registers in real time is provided by reconfiguring Data Watchpoint and Trace (DWT), which is an existing debugging feature of ARM-based processors, as a security monitoring function.

According to the disclosed embodiment, limited watchpoint resources may be efficiently used by dynamically changing and expanding the monitoring range of DWT through a time-sharing method using an RTOS timer. Accordingly, a wider monitoring range may be provided.

According to the disclosed embodiment, access to specific registers is detected, and such detection is connected with a handler function to expand to an anomaly detection function. Accordingly, the capability to detect and handle abnormal operations in real time is enhanced, whereby the security of an embedded device is greatly improved while minimizing the performance degradation of the embedded device.

According to the disclosed embodiment, real-time security monitoring is effectively performed by efficiently using limited hardware resources, and the capability to quickly detect and respond to external attacks and abnormal operations is provided, whereby the stability and reliability of an embedded device may be improved.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for real-time security monitoring of an embedded system, comprising:
identifying one or more protection targets in an embedded system;
generating trap code for watchpoint-based monitoring for each of the identified one or more protection targets;
setting a detection interval for each of the one or more protection targets;
porting the generated trap code to correspond to the detection interval set for each of the protection targets;
performing security monitoring for each of the one or more protection targets at the detection interval set for the protection target when the embedded system operates; and
performing exception handling by executing the ported trap code when abnormal access is detected.

2. The method of claim 1, wherein the protection targets include at least one of Static Random-Access Memory (SRAM), external RAM, a peripheral, a Direct Memory Access (DMA) control block, or a Memory-Mapped I/O (MMIO) region, or a combination thereof.

3. The method of claim 1, wherein identifying the one or more protection targets comprises determining the protection targets based on a result of analyzing an external device operating in conjunction with the embedded system, processor information, and an operation method.

4. The method of claim 1, wherein the detection interval is set depending on importance of the protection target.

5. The method of claim 1, wherein setting the detection interval comprises setting a Real-Time Operating System (RTOS) timer for the detection interval of each of the one or more protection targets.

6. The method of claim 1, wherein performing the security monitoring comprises dynamically resetting the one or more protection targets in a single Data Watchpoint and Trace (DWT) watchpoint register.

7. The method of claim 1, wherein performing the exception handling comprises calling, by the executed trap code, an exception handler routine defined in the embedded system and performing at least one of blocking access to the protection target, rebooting the embedded system, or switching to a defensive mode, or a combination thereof.

8. The method of claim 7, wherein performing the exception handling comprises transmitting an abnormal access log to a security server or transmitting a warning message to an administrator of the embedded system.

9. An apparatus for real-time security monitoring of an embedded system, comprising:
memory in which at least one program is recorded; and
a processor for executing the program,
wherein the processor identifies one or more protection targets in an embedded system, generates trap code for watchpoint-based monitoring for each of the identified one or more protection targets, sets a detection interval for each of the one or more protection targets, ports the generated trap code to correspond to the detection interval set for each of the protection targets, performs security monitoring for each of the one or more protection targets at the detection interval set for the protection target when the embedded system operates, and performs exception handling by executing the ported trap code when abnormal access is detected.

10. The apparatus of claim 9, wherein the protection targets include at least one of Static Random-Access Memory (SRAM), external RAM, a peripheral, a Direct Memory Access (DMA) control block, or a Memory-Mapped I/O (MMIO) region, or a combination thereof.

11. The apparatus of claim 9, wherein, when identifying the one or more protection targets, the processor determines the protection targets based on a result of analyzing an external device operating in conjunction with the embedded system, processor information, and an operation method.

12. The apparatus of claim 9, wherein the detection interval is set depending on importance of the protection target.

13. The apparatus of claim 9, wherein, when setting the detection interval, the processor sets a Real-Time Operating System (RTOS) timer for the detection interval of each of the one or more protection targets.

14. The apparatus of claim 9, wherein, when performing the security monitoring, the processor performs time-sharing monitoring by dynamically resetting the one or more protection targets in a single Data Watchpoint and Trace (DWT) watchpoint register.

15. The apparatus of claim 9, wherein, when performing the exception handling, the processor causes the executed trap code to call an exception handler routine defined in the embedded system and performs at least one of blocking access to the protection target, rebooting the embedded system, or switching to a defensive mode, or a combination thereof.

16. The apparatus of claim 15, wherein, when performing the exception handling, the processor transmits an abnormal access log to a security server or transmits a warning message to an administrator of the embedded system.

17. A method for real-time security monitoring of an embedded system, comprising:
performing security monitoring for each of two or more protection targets at a time-sliced detection interval preset for the protection target by utilizing a single watchpoint register when an embedded system operates; and
performing exception handling in such a way that the protection target executes previously ported trap code when abnormal access is detected.

18. The method of claim 17, wherein the protection targets include at least one of Static Random-Access Memory (SRAM), external RAM, a peripheral, a Direct Memory Access (DMA) control block, or a Memory-Mapped I/O (MMIO) region, or a combination thereof.

19. The method of claim 17, wherein a Real-Time Operating System (RTOS) timer is set for the time-sliced detection interval of each of the two or more protection targets.

20. The method of claim 17, wherein performing the exception handling comprises calling, by the executed trap code, an exception handler routine defined in the embedded system and performing at least one of blocking access to the protection target, rebooting the embedded system, or switching to a defensive mode, or a combination thereof.
